(19) United States
(12) Patent Application Publication
(10) Pub. No.: US 2008/0075501 A1
(43) Pub. Date: Mar. 27, 2008

(54) IMAGE FORMING APPARATUS AND METHOD THEREOF

(75) Inventor: Hyun-woo KIM, Busan (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/770,784

(22) Filed: Jun. 29, 2007

(30) Foreign Application Priority Data
Sep. 22, 2006 (KR) 2006-92289

(51) Int. Cl. G03G 21/18

(52) U.S. Cl. 399/111

(57) ABSTRACT

An image forming apparatus includes a main body frame, a developing cartridge provided to be attached to and detached from the main body frame, a button which is provided in one of the main body frame and the developing cartridge and which is coupled to and separated from the other one thereof, and a button accommodating part which is provided in the other one of the main body frame and the developing cartridge and which is coupled to the button.

### CROSS-REFERENCE TO RELATED APPLICATIONS

This application claims priority under 35 U.S.C. §119(a) from Korean Patent Application No. 10-2006-0092289, filed on Sep. 22, 2006 in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus in which a developing cartridge can be easily attached to and detached from a main body frame.

2. Description of the Related Art

A conventional image forming apparatus prints image data generated or stored in a host apparatus on a printing paper according to an output signal. Such an image forming apparatus comprises a photosensitive body on which an electrostatic latent image is formed, a developing device for selectively developing developer on the photosensitive body, and a transferring means for transferring the developer developed on the photosensitive body on a printing paper to print a desired image on the printing paper. The image forming apparatus comprises a printer, a photocopier, a scanner, and a multi-functional device comprising these configurations.

The conventional image forming apparatus comprises a main body having a feeding part, a transferring part, and a light scanning unit, and a developing cartridge which is provided to be attached to or detached from the main body, and which comprises a photosensitive body and a developing roller, and in which developer is stored. The developing cartridge is replaced with a new developing cartridge recharged with new developer if the developer is used up.

FIG. 1 is a perspective view illustrating a process in which a developing cartridge 120 is coupled to a main body frame 110 in a conventional image forming apparatus 100. As illustrated in FIG. 1, in the conventional image forming apparatus 100, a user presses the developing cartridge 120 toward the main body frame 110 in the direction of an arrow to mount the developing cartridge 120 to an inside portion of the main body frame 110. If the developing cartridge 120 is entirely mounted to the main body frame 110, an elastic member 130 provided on opposite sides of the main body frame 110 applies an elastic force to an opposite direction with respect to a direction in which the developing cartridge 120 is mounted, to enable the developing cartridge 120 to maintain its position.

Considering that the elastic force by the elastic member 130 provided as a torsion spring is applied in parallel with a moving direction of the developing cartridge 120, the conventional image forming apparatus 100 is designed to have a middle value of an elastic force by which the user can easily attach or detach the developing cartridge 120, and the elastic force by which the developing cartridge 120 can be stably supported in the main body frame 110. However, the elastic force of the elastic member 130 may not satisfy both the above-described conditions. That is, if the elastic force is large, the user has a difficulty in attaching or detaching the developing cartridge 120, and in contrast, if the elastic force is small, the developing cartridge 120 is moved during an image forming process, thereby lowering the image quality.

### SUMMARY OF THE INVENTION

The present general inventive concept provides an image forming apparatus which a user can easily attach and/or detach a developing cartridge to and/or from a main body frame.

The present general inventive concept also provides an image forming apparatus capable of stably coupling a developing cartridge to a main body and maintaining uniform image quality.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept are achieved by providing an image forming apparatus, comprising a main body frame, a developing cartridge provided to be attached to and detached from the main body frame, a button which is provided in one of the main body frame and the developing cartridge and which is coupled to and separated from the other one thereof, and a button accommodating part which is provided in the other one of the main body frame and the developing cartridge and which is coupled to the button.

The button may be provided in one of the main body frame and the developing cartridge and may be projected and retracted with respect to the other one thereof.

The button may comprise a button main body, and an elastic member which is coupled to the button main body and may apply an elastic force so that the button main body can be elastically projected and retracted.

The button main body may comprise an inclined plane provided on one side thereof to be inclined in a predetermined angle with respect to a coupling method of the developing cartridge.

The button main body may further comprise a flange extended in a transverse direction to the projected direction of the button main body.

The flange may have a decreased width as it reaches a leading edge of the button main body closer.

The button accommodating part may comprise a flange accommodating part to accommodate the flange on one side.

The foregoing and/or other aspects and utilities of the present general inventive concept may also be achieved by providing an image forming apparatus, comprising, a main body frame, a developing cartridge provided to be attached to and detached from the main body frame, a button which is provided in one of the main body frame and the developing cartridge and is projected and retracted with respect to the other one thereof, an elastic member which is provided on one side of the button and applies an elastic force so that the button can be projected and retracted, and a button accommodating part which is provided in the other one of the main body frame and the developing cartridge and accommodates the button.

The button may comprise an inclined plane which is provided in a transverse direction to the projected direction of the button with respect to the button accommodating part and may enable the button to be retracted.

The inclined plane may be provided as a curvature.

The button may comprise a flange extended in a transverse direction to the projected direction of the button.

The flange may have a decreased width as it reaches a leading edge of the button closer.

The button accommodating part may comprise a flange accommodating part to accommodate the flange on one side thereof.

The foregoing and/or other aspects and utilities of the present general inventive concept may also be achieved by providing an image forming apparatus, comprising a main body frame; a developing cartridge to be inserted into the main body frame, and at least one coupling member to couple the developing cartridge to the main body frame in a direction transverse to a direction in which the developing cartridge is inserted.

The main body frame may comprise at least one cartridge contact surface to contact a respective one of the at least one coupling member, and a coupling member accommodating part provided in each of the at least one cartridge contact surface to accommodate a respective one of the at least one coupling member therein.

The at least one coupling member is in a retracted state when in contact with the at least one cartridge contact surface and the at least one coupling member is in a projected state when accommodated in the coupling member accommodating part.

The at least one coupling member may comprise a retractable button main body to retract when in contact with the main body frame, and a flange inclined with respect to the button main body to allow the button main body to retract.

The main body frame may further comprise a coupling member accommodating part to accommodate the button main body and the flange in a state where the developing cartridge is attached to the main body frame.

The image forming apparatus may further comprise a knob part to move in a direction transverse to the image forming direction and a direction transverse to the developing cartridge coupling direction to retract the at least one coupling member to allow the developing cartridge to be detached.

The foregoing and/or other aspects and utilities of the present general inventive concept may also be achieved by providing a method of attaching and detaching a developing cartridge to an image forming device with a main body, the method comprising engaging coupling members of the developing cartridge into accommodating holes of the image forming device when attaching the developing cartridge to the image forming device, and separating the coupling members from the accommodating holes of the image forming device when detaching the developing cartridge from the image forming device.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings, in which:

FIG. 1 is a perspective view illustrating a process in which a developing cartridge is coupled to a main body frame in a conventional image forming apparatus.

FIG. 2 is a sectional view schematically illustrating a configuration of an image forming apparatus according to an embodiment of the present general inventive concept.

FIG. 3 is a perspective view illustrating a process in which a main body frame is coupled to a developing cartridge according to an embodiment of the present general inventive concept.

FIGS. 4A and 4B are a sectional view and a perspective view illustrating a configuration of a button according to an embodiment of the present general inventive concept.

FIG. 5 is a plane view illustrating the shape of a button accommodating part according to the present general inventive concept.

FIGS. 6A to 6C are exemplary views illustrating a process in which a button is being mounted to a main body frame according to an embodiment of the present general inventive concept.

FIGS. 7A to 7C are exemplary views illustrating a state in which a developing cartridge is coupled to a main body frame according to an embodiment of the present general inventive concept.

FIGS. 8A to 8C are exemplary views illustrating a state in which a developing cartridge is being detached from a main body frame according to an embodiment of the present general inventive concept.

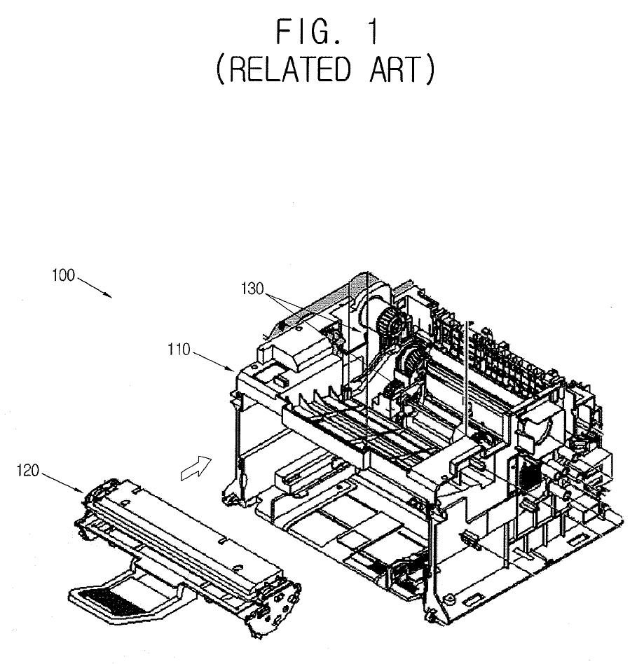

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

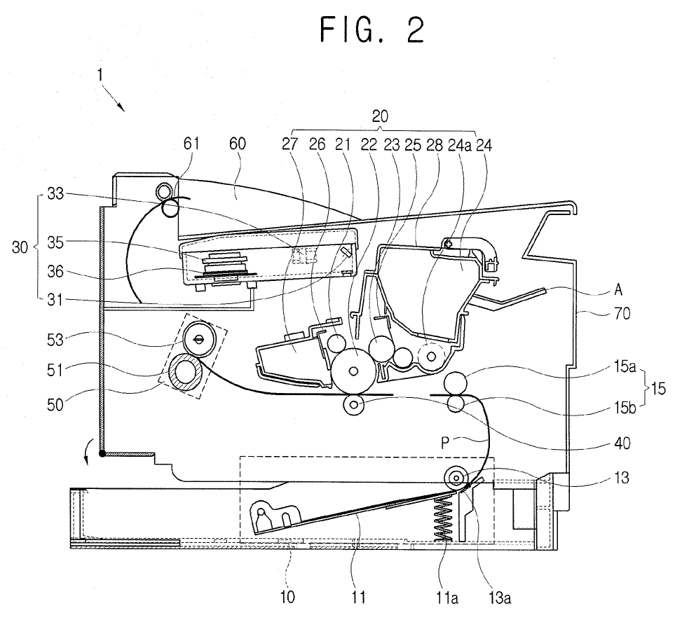

As illustrated in FIG. 2, an image forming apparatus 1 according to the present general inventive concept comprises a feeding part 10 to store printing papers and to supply a printing paper to a developing cartridge 20, the developing cartridge 20 which is provided to be attached to or detached from a main body casing 70 to form an image on the printing paper, a light scanning unit 30 to scan light onto a photosensitive body 22 of the developing cartridge 20 to form an electrostatic latent image, a transferring unit 40 to transfer developer adhered to the photosensitive body 22 to the printing paper, a fixing part 50 to apply heat and pressure to the developer-adhered paper to fix an image thereon, a discharging part 60 to discharge the printed paper, and the main body casing 70 to support the above components.

The feeding part 10 comprises a knock-up plate 11 to store the printing paper, an elastic member 11a to elevate the knock-up plate 11 toward a pick-up roller 13, the pick-up roller 13 to pick up the printing paper of the knock-up plate 11, and a feeding roller 15 to feed the printing paper picked up in the pick-up roller 13 between the developing cartridge 20 and the transferring unit 40. The feeding part 10 is detachably provided to the main body casing 70 and elastically moves upward with respect to the knock-up plate 11 and toward the pick-up roller 13 according to a printing signal supplied from a host apparatus (not illustrated) to feed the printing paper. The pick-up roller 13 applies a frictional force to the paper on the knock-up plate 11 to feed the printing paper. Accordingly, the pick-up roller 13 feeds only a printing paper at the top of the pile according to an engagement with an overlapping preventing member 13a provided on one side thereof.

The feeding roller 15 is provided on a paper feeding route between the pick-up roller 13 and the developing cartridge 20 to facilitate feeding of the printing paper. The feeding roller 15 is also provided with a driving roller 15a which is rotated by a driving part (not illustrated) to feed a printing paper, and an idle roller 15b which rotates in engagement with the driving roller 15a. The feeding roller 15 may be provided in plurality according to a configuration and a shape of the paper feeding route.

The developing cartridge 20 comprises a photosensitive body 22, an electrifying roller 21 to electrify the photosensitive body 22 into a predetermined electric potential, a developing roller 23 to coat developer on the photosensitive body 22, a developer storing part 24 to store developer, a supplying roller 24a to supply the developer in the developer storing part 24 to the photosensitive body 22, a doctor blade 25 to adjust an amount of the developer supplied in the supplying roller 24a to have a uniform thickness, a cleaning blade 26 to remove the developer on the surface of the photosensitive body 22 after transferring developer onto the printing paper, a waste toner storing part 27 to collect the waste toner separated from the surface of the photosensitive body 22 by the cleaning blade 26, and a casing 28 to accommodate the above components.

A description of a configuration of the photosensitive body 22, the electrifying roller 21, the supplying roller 24a, the doctor blade 25, the cleaning blade 26, and the waste toner storing part 27 will be omitted as it is the same as the conventional configuration.

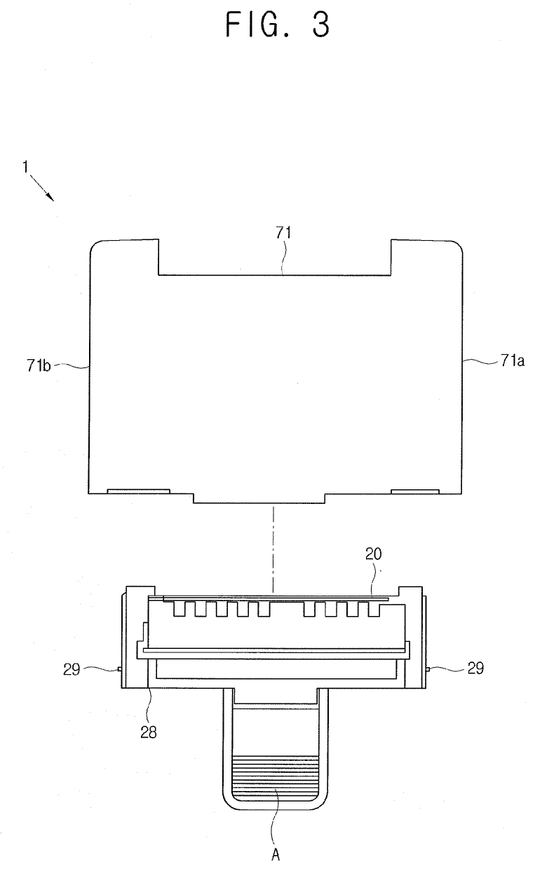

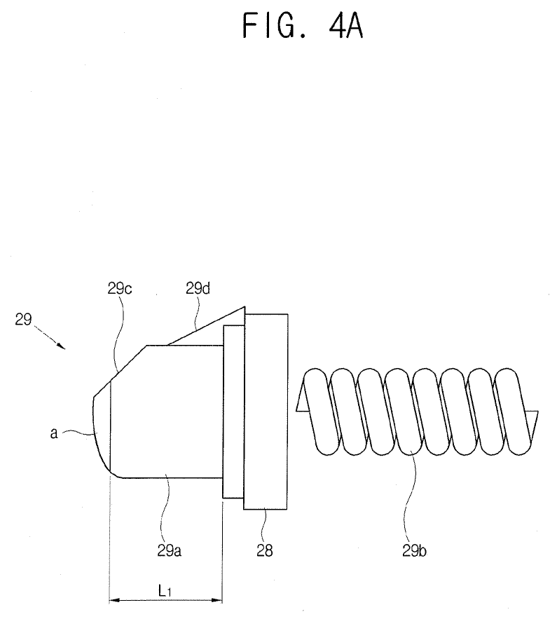

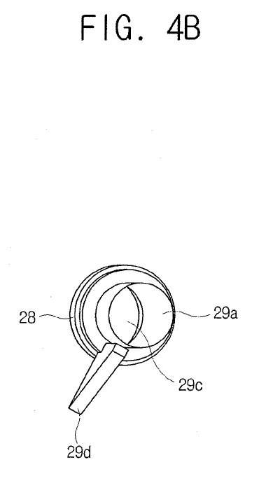

The casing 28 is attached to or detached from the main body casing 70. As illustrated in FIG. 3, the casing 28 comprises a button 29 which is provided to be projected and retracted in a transverse direction to the direction in which the casing 28 is mounted to the main body frame 71 of the main body casing 70, which is to be coupled to the main body frame 71, and a button accommodating hole (not illustrated) into which the button 29 is inserted when the button 29 is retracted. As illustrated in FIGS. 4A and 4B, the button 29 comprises a button main body 29a provided to be projected and retracted, an elastic member 29b provided inside the button main body 29a to apply an elastic force so that the button main body 29a can be projected and retracted with respect to the casing 28, an inclined plane 29c provided in one area of the button main body 29a to guide the button main body 29a to be retracted with respect to the main body frame 71, and a flange 29d extending in a transverse direction to the projected direction of the button main body 29a.

The button main body 29a is provided to have a circular or a polygonal section. Also, the button main body 29a may project by a predetermined length L1 from a planar surface of the casing 28. The button 29 comprises the inclined plane 29c provided to be inclined from a contact surface a of the button main body 29a. The inclined plane 29c is provided to be inclined over a predetermined area of the contact surface a and contacts with the main body frame 71 to guide the button main body 29a to be retracted when the developing cartridge 20 is coupled to the main body frame 71. The inclined plane 29c may be provided to be inclined or to have a curved surface having a predetermined curvature. Accordingly, the contact surface a may have a planar surface or a predetermined curvature as described above.

Between the button main body 29a and the casing 28 is provided an elastic member 29b. The button main body 29a can be provided in a hollowed shape, and the elastic member 29b may be inserted into an inside portion of the hollow section of the main body 29a. One end part of the elastic member 29b is coupled to the casing 28 and the opposite end part thereof is coupled to the button main body 29a to be elastically retracted into and projected from the button accommodating part 72 when the button main body 29a contacts with the main body frame 71. The elastic member 29b may be provided as a coil spring. Also, the elastic member 29b may have a proper elastic coefficient so that the button main body 29a contacted with the main body frame 71 can be easily retracted when a user presses the button 29. Meanwhile, the elastic member 29b may be provided as other known means having elasticity instead of the coil spring.

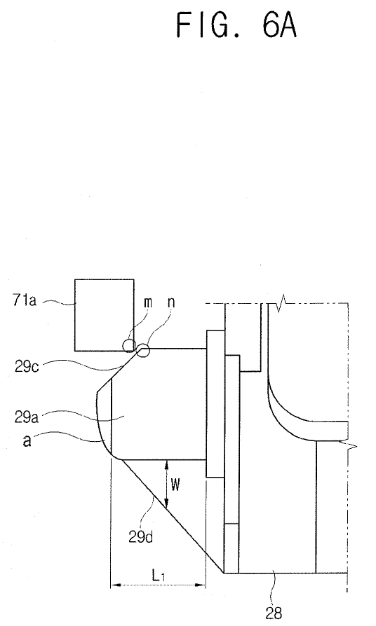

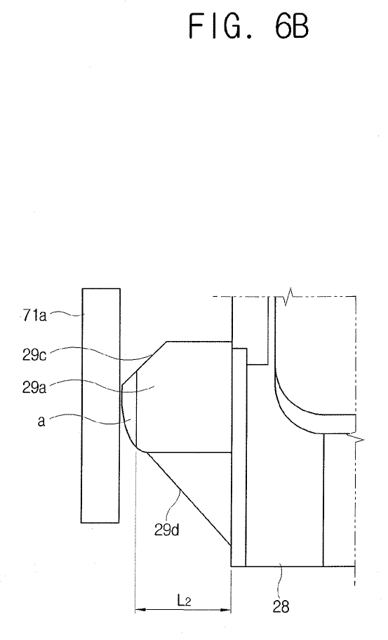

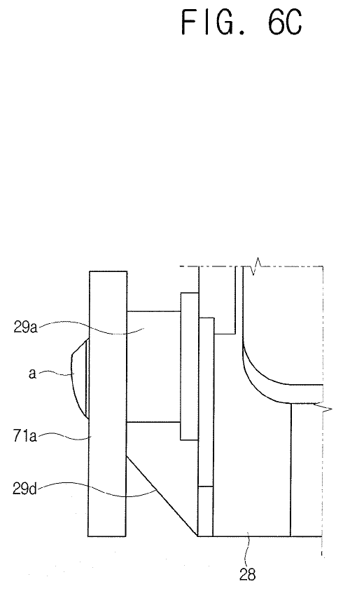

The flange 29d extends in a transverse direction to the projected direction of the button main body 29a. As illustrated in FIG. 6A, the flange 29d may be provided to have a decreasing width W as it approaches the contact surface a of the button main body 29a from the casing 28. Accordingly, when the user rotates the developing cartridge 20 so as to detach the developing cartridge 20 from the main body frame 71, the flange 29d can be separated from the flange accommodating part 72 to pressurize the main body frame 71, and the button main body 29a can be separated from the button accommodating part 72.

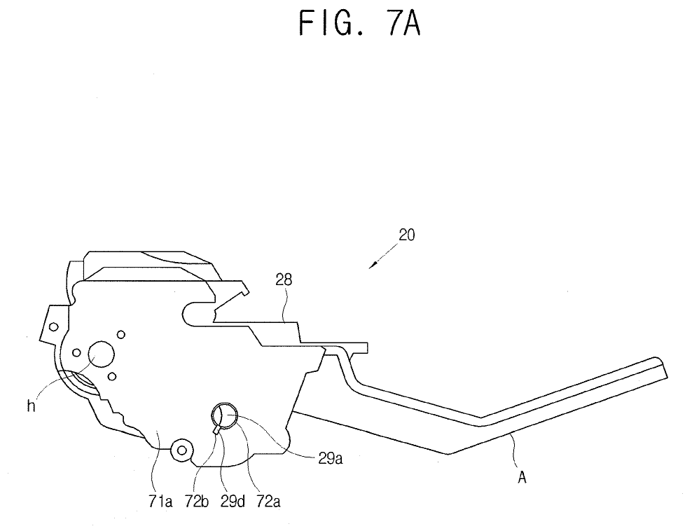

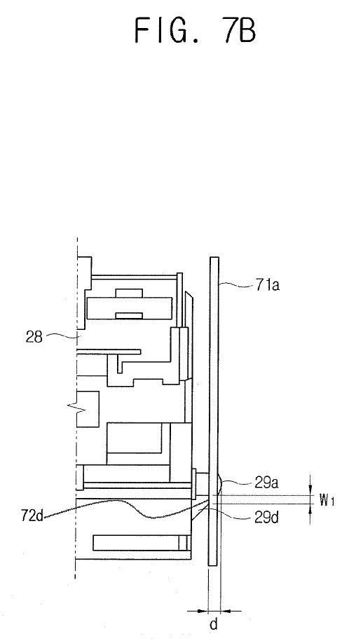

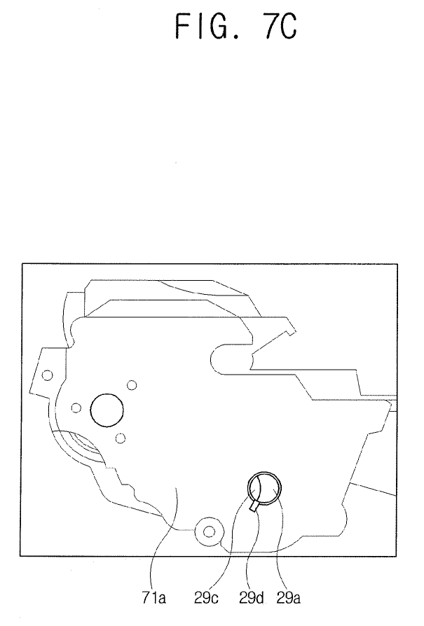

As illustrated in FIG. 7A, in the one end part of the casing 28 is provided a knob part A to be easily held by the user when the user attaches or detaches the developing cartridge 20. The knob part A extends from the developing cartridge 20 by a predetermined length and is provided to be rotated in a predetermined angle with respect to a rotating shaft h of the casing 28, as illustrated in FIG. 7A.

Referring back to FIG. 2, the light scanning unit 30 comprises a light source 31 to generate light, a lens unit 33 to condense the light generated in the light source 31 toward a direction of a polygon mirror 35, the polygon mirror 35 to rotationally scan the light taken through the lens unit 33 toward a sub scanning direction of the photosensitive body 22, and a driving motor 36 to drive the polygon mirror 35. A description of the configuration of the light scanning unit 30 will be omitted as it is the same as a conventional light scanning unit.

The transferring unit 40 supplies a transferring voltage on the developer coated on the surface of the photosensitive body 22 by a potential difference to transfer the developer onto the printing paper. The transferring unit 40 supplies an optimum transferring voltage by sensing a type and characteristics of the printing paper. A description of the configuration of the transmitting unit 40 will be omitted as it is the same as a conventional transmitting unit.

The fixing part 50 applies heat and pressure to the printing paper on which developer is coated by the transferring unit 40 to fix an image on the printing paper. The fixing part 50 comprises a heating roller 53 to apply heat to the paper, and a pressing roller 51 to apply pressure to the paper. The printing paper passes through a nip formed between the heating roller 53 and the pressing roller 51 to be pressed with its developer, and the image is fixed thereon.

The discharging part 60 discharges the printed paper passing through the fixing part 50 to an area outside the image forming apparatus 1. The discharging part 60 comprises a discharging roller 61 to guide the printed paper of the fixing part 50 to the discharging part 60.

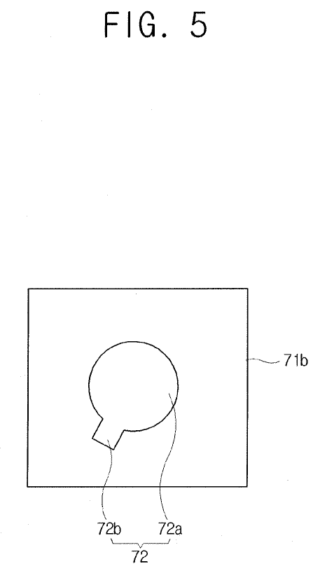

Referring back to FIG. 3, the casing 70 comprises a main body frame 71 to support the above-described configurations. The main body frame 71 accommodates the developing cartridge 20 to be attached thereto or detached therefrom the outside the image forming apparatus 1. As illustrated in FIG. 5, cartridge contact surfaces 71a and 71b, to which the developing cartridge 20 is coupled and contacted in the main body frame 71, is provided with a button accommodating part 72 to accommodate the button 29. The button accommodating part 72 comprises a button main body accommodating part 72a to accommodate the button main body 29a, and a flange accommodating part 72b to accommodate the flange 29d. The button accommodating part 72a and the flange accommodating part 72b may be integrally provided.

The button main body accommodating part 72a corresponds to the shape of the button main body 29a and may have a diameter similar to that of the button main body 29a so that the button main body 29a can be fixed within the button main body accommodating part 72a. Accordingly, it is possible to fixedly support the developing cartridge 20 while forming an image, so that the image is stably formed.

As illustrated in FIG. 7B, a length of the flange accommodating part 72b is provided to be adaptable to an extended width W1 of the flange 29d corresponding to a length d of the button main body 29a to be accommodated in the button main body accommodating part 72a. Further, the flange accommodating part 72b may be formed to correspond to a direction of the flange 29d when the developing cartridge 20 is mounted.

An attaching and detaching process of the image forming apparatus 1 with the above configuration according to an embodiment of the present general inventive concept will be described by referring to FIGS. 3 and 5A through 8C.

First, the user presses the knob part A of the developing cartridge 20 toward the main body frame 70, as illustrated in FIG. 3. If the developing cartridge 20 is in contact with the cartridge contact surfaces 71a and 71b of the main body frame 71 when the user presses the knob part A, a curved area n of the inclined plane 29c of the button 29 contacts an edge area m of the cartridge contact surface 71a, as illustrated in FIG. 6A. Accordingly, the edge area m presses the inclined plane 29c and the button 29 retracts, as illustrated in FIG. 6B. The developing cartridge 20 keeps pressing the inside of the main body frame 70 in a state in which the button is retracted, and the button 29 continues to maintain a retracted length L2.

Then, as illustrated in FIG. 6C, if the button 29 reaches a position corresponding to the button accommodating part 72, the button main body 29a and the flange 29d are inserted into the button accommodating part 72 to be fully extended.

As illustrated in FIG. 7A, the developing cartridge 20 mounted to the main body frame 71 does not move to a moving direction, but instead maintains a stable position when forming an image since the button 29 applies force to the main body frame 71 toward a vertical direction with respect to the moving direction of the developing cartridge 20.

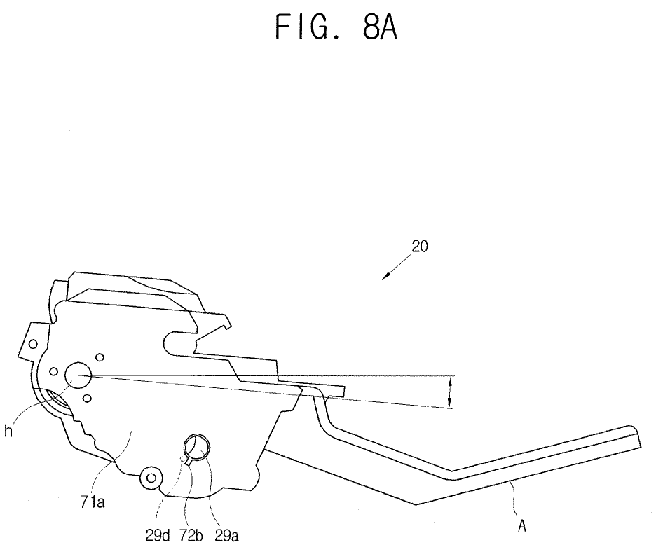

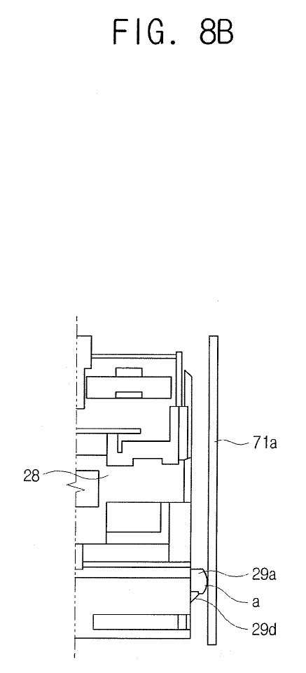

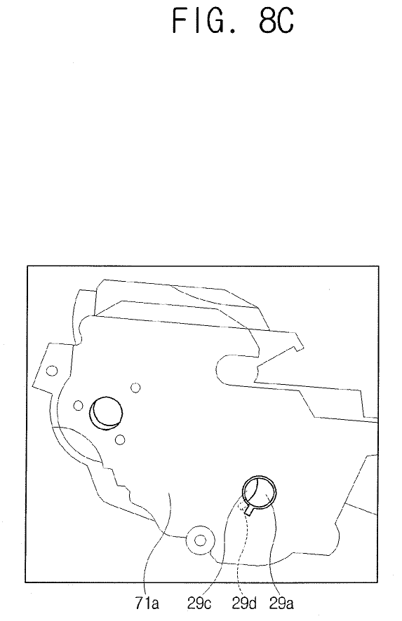

If the developing cartridge 20 needs to be detached from the main body frame 71 since the developer stored in the developing cartridge 20 is used up, or if a paper jam is generated, the user rotates the knob part A illustrated in FIG. 7A in a downward direction as illustrated in FIG. 8A. The flange 29d accommodated in the flange accommodating part 72d, as illustrated in FIG. 7B, by the rotation of the developing cartridge 20, is separated from the cartridge contact surface 71a, as illustrated in FIG. 8B, to be pressed onto the cartridge contact surface 71a.

Accordingly, the button main body 29a accommodated in the button accommodating part 72a is rotated to be retracted. The user may pull the developing cartridge 20 toward an exterior direction of the main body frame 71 in a state in which the button 29 is retracted, as illustrated in FIG. 8C, to detach the developing cartridge 20.

As described above, a developing cartridge according to an embodiment of the present general inventive concept can be easily attached to or detached from a main body frame by projecting and retracting a button. Also, a user can mount a developing cartridge to the main body frame by exerting minimal force due to an inclined plane of the button. Further, since a flange of the button is rotated and the button is separated from a button accommodating part to be retracted by rotating the developing cartridge in a predetermined angle so as to detach the developing cartridge, detaching the developing cartridge can be performed with a little force.

In addition, the developing cartridge according to the present general inventive concept can be stably operated during an image forming process due to a difference from a direction in which the developing cartridge is detached and a direction in which the developing cartridge is coupled to the main body frame. Hence, the image quality can be uniformly maintained.

Also, the user can detach the developing cartridge using minimal force, thereby preventing the developing cartridge from being broken when detaching the conventional developing cartridge from the main body frame.

Furthermore, a button is provided to be projected and retracted, and the button accommodating part to accommodate the button is provided in the main body frame, in the developing cartridge according to an exemplary embodiment of the present general inventive concept, but alternatively, the button may be provided in the main body frame and the button accommodating part may be provided in the developing cartridge.

Also, one button and one button accommodating part are provided in an exemplary embodiment of the present general inventive concept, but alternatively, the button and the button accommodating part may be provided in plurality in consideration of a capacity of the developing cartridge.

Also, the button and the button accommodating part may be used in a color image forming apparatus as well as a mono image forming apparatus.

As described above, according to the present general inventive concept, there is provided an image forming apparatus which a user can attach and/or detach a developing cartridge to and/or from a main body frame using minimal force by a configuration of a button and a button accommodating part.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a main body frame;
a developing cartridge provided to be attached to and detached from the main body frame;
a button provided in one of the main body frame and the developing cartridge and coupled to and separated from the other one of the main body frame and the developing cartridge; and
a button accommodating part to couple with and be separated from the button and provided in the other one of the main body frame and the developing cartridge.

2. The image forming apparatus according to claim 1, wherein the button is provided in one of the main body frame and the developing cartridge and is projected and retracted with respect to the other one of the main body frame and the developing cartridge.

3. The image forming apparatus according to claim 2, wherein the button comprises:
a button main body; and
an elastic member coupled to the button main body and applies an elastic force so that the button main body can be elastically projected and retracted.

4. The image forming apparatus according to claim 3, wherein the button main body comprises:
an inclined plane provided on one side thereof to be inclined in a predetermined angle with respect to a coupling method of the developing cartridge.

5. The image forming apparatus according to claim 4, wherein the button main body further comprises:
a flange that extends in a transverse direction to the projected direction of the button main body.

6. The image forming apparatus according to claim 5, wherein a width of the flange decreases as it approaches a leading edge of the button main body.

7. The image forming apparatus according to claim 5, wherein the button accommodating part comprises:
a flange accommodating part to accommodate the flange on one side.

8. The image forming apparatus according to claim 6, wherein the button accommodating part comprises:
a flange accommodating part to accommodate the flange on one side.

9. An image forming apparatus, comprising:
a main body frame;
a developing cartridge provided to be attached to and detached from the main body frame;
a button provided in one of the main body frame and the developing cartridge and is projected and retracted with respect to the other one of the main body frame and the developing cartridge;
an elastic member provided on one side of the button and applies an elastic force so that the button can be projected and retracted; and
a button accommodating part provided in the other one of the main body frame and the developing cartridge to accommodate the button.

10. The image forming apparatus according to claim 9, wherein the button comprises:
an inclined plane provided in a transverse direction to the projected direction of the button with respect to the button accommodating part to enable the button to be retracted.

11. The image forming apparatus according to claim 10, wherein the inclined plane is provided as a curvature.

12. The image forming apparatus according to claim 9, wherein the button comprises:
a flange that extends in a transverse direction to the projected direction of the button.

13. The image forming apparatus according to claim 12, wherein a width of the flange decreases as it approaches a leading edge of the button.

14. The image forming apparatus according to claim 12, wherein the button accommodating part comprises:
a flange accommodating part to accommodate the flange on one side thereof.

15. The image forming apparatus according to claim 13, wherein the button accommodating part comprises:
a flange accommodating part to accommodate the flange on one side thereof.

16. An image forming apparatus, comprising:
a main body frame;
a developing cartridge to be inserted into the main body frame; and
at least one coupling member to couple the developing cartridge to the main body frame in a direction transverse to a direction in which the developing cartridge is inserted.

17. The image forming apparatus of claim 16, wherein the main body frame comprises:
at least one cartridge contact surface to contact a respective one of the at least one coupling member; and
a coupling member accommodating part provided in each of the at least one cartridge contact surface to accommodate a respective one of the at least one coupling member therein.

18. The image forming apparatus of claim 17, wherein the at least one coupling member is in a retracted state when in contact with the at least one cartridge contact surface and the at least one coupling member is in a projected state when accommodated in the coupling member accommodating part.

19. The image forming apparatus of claim 16, wherein the at least one coupling member comprises:
a retractable button main body to retract when in contact with the main body frame; and
a flange inclined with respect to the button main body to allow the button main body to retract.

20. The image forming apparatus of claim 19, wherein the main body frame further comprises:
a coupling member accommodating part to accommodate the button main body and the flange in a state where the developing cartridge is attached to the main body frame.

21. The image forming apparatus of claim 16, further comprising:
a knob part to move in a direction transverse to the direction in which the developing cartridge is inserted and a direction transverse to the developing cartridge coupling direction to retract the at least one coupling member to allow the developing cartridge to be detached.

22. A method of attaching and detaching a developing cartridge to an image forming device with a main body, the method comprising:
engaging coupling members of the developing cartridge into accommodating holes of the image forming device when attaching the developing cartridge to the image forming device; and
separating the coupling members from the accommodating holes of the image forming device when detaching the developing cartridge from the image forming device.
